(19) United States
(12) Patent Application Publication
(10) Pub. No.: US 2021/0398352 A1
(43) Pub. Date: Dec. 23, 2021

(54) 3D DATA GENERATION APPARATUS, 3D DATA RECONSTRUCTION APPARATUS, CONTROL PROGRAM, AND RECORDING MEDIUM

(71) Applicant: Sharp Kabushiki Kaisha, Sakai City, Osaka (JP)

(72) Inventor: Yasuaki TOKUMO, Sakai City (JP)

(21) Appl. No.: 17/279,130

(22) PCT Filed: Sep. 27, 2019
(86) PCT No.: PCT/JP2019/038194

§ 371 Date: Mar. 24, 2021

(30) Foreign Application Priority Data
Sep. 28, 2018 (JP) 2018-183903

(51) Int. Cl. G06T 17/20; G06T 9/20; G06T 7/55

(52) U.S. Cl. CPC G06T 17/20; G06T 2207/10024; G06T 7/55; G06T 9/20

(57) ABSTRACT

In order to generate a high definition 3D model based on a depth, a certain degree of resolution is required for the depth, but in a case of coding a depth image using an existing codec, depending on the size and movement of an imaging target, the dynamic range of the depth is wide and the resolution is insufficient in some cases. A 3D data generation apparatus to which a depth image representing a three-dimensional shape of one or a plurality of imaging targets is input and which generates 3D data, the 3D data generation apparatus including: a depth division unit configured to divide the depth image into a plurality of partial depth images each including a rectangular region; a depth integration unit configured to perform packing of the plurality of partial depth images and to generate an integrated depth image; a depth image coder configured to code the integrated depth image; and an additional information coder configured to code additional information including division information for identifying the rectangular region and information for indicating the packing.

### TECHNICAL FIELD

An aspect of the present invention relates to a 3D data generation apparatus to which a depth image representing a three-dimensional shape of an imaging target is input and which generates 3D data, a 3D data generation method, a control program, and a recording medium.

### BACKGROUND ART

In the field of CG, a method called DynamicFusion of constructing a 3D model (three-dimensional model) by integrating input depths is being studied. The purpose of DynamicFusion is mainly to construct a 3D model from which noise is removed in real time from a captured input depth. In DynamicFusion, the input depth obtained from a sensor is integrated into a common reference 3D model after compensation for three-dimensional shape deformation. This makes it possible to generate a precise 3D model from a low resolution and high noise depth.

Furthermore, PTL 1 discloses a technology of outputting an image of an arbitrary view point by inputting a multi-view point color image and a multi-view point depth image corresponding thereto in a pixel level.

### CITATION LIST

### Patent Literature

PTL 1: JP 2013-30898 A

### SUMMARY OF INVENTION

### Technical Problem

In order to generate a high definition 3D model based on a depth, a certain degree of resolution is required for the depth, but in a case of coding a depth image using an existing codec, depending on the size and movement of an imaging target, the dynamic range of the depth is wide and the resolution is insufficient in some cases.

### Solution to Problem

In order to solve the problem described above, a 3D data generation apparatus according to an aspect of the present invention is a 3D data generation apparatus to which a depth image representing a three-dimensional shape of one or a plurality of imaging targets is input and which generates 3D data, the 3D data generation apparatus including: a depth division unit configured to divide the depth image into a plurality of partial depth images each including a rectangular region; a depth integration unit configured to perform packing of the plurality of partial depth images and generate an integrated depth image; a depth image coder configured to code the integrated depth image; and an additional information coder configured to code additional information including division information for identifying the rectangular region and information for indicating the packing.

In order to solve the problem described above, a 3D data reconstruction apparatus according to an aspect of the present invention is a 3D data reconstruction apparatus to which 3D data are input and which reconstructs a three-dimensional shape of one or a plurality of imaging targets, the 3D data reconstruction apparatus including: a depth image decoder configured to decode an integrated depth image included in the 3D data; an additional information decoder configured to decode additional information including information for indicating packing of a plurality of partial depth images each including a rectangular region included in the integrated depth image and division information for specifying the rectangular region; a depth extraction unit configured to extract, from the integrated depth image which is decoded, a partial depth image of the plurality of partial depth images based on the information for indicating the packing; and a depth coupling unit configured to couple the plurality of partial depth images based on the division information and reconstruct a depth image.

### Advantageous Effects of Invention

According to an aspect of the present invention, even in a case that a dynamic range of a depth of an imaging target is wide, 3D data with little quantization error can be generated using an existing codec.

### BRIEF DESCRIPTION OF DRAWINGS

FIG. 1 is a functional block diagram illustrating a constitution of a 3D data generation apparatus according to Embodiment 1 of the present invention.

FIG. 2 is a functional block diagram illustrating internal constitutions of an integrated depth image generation unit and an integrated color image generation unit according to Embodiment 1 of the present invention.

FIG. 3 is a diagram illustrating an acquisition example of a depth image and a color image according to Embodiment 1 of the present invention.

FIG. 4 is a diagram illustrating an example of depth images output by a depth image acquisition unit and color images output by a color image acquisition unit according to Embodiment 1 of the present invention.

FIG. 5 is a diagram illustrating a division example of the depth images according to Embodiment 1 of the present invention.

FIG. 6 is a diagram illustrating a packing example of the depth images and the color images according to Embodiment 1 of the present invention.

FIG. 7 is a diagram illustrating a division example of the color images according to Embodiment 1 of the present invention.

FIG. 8 is a functional block diagram illustrating a constitution of a 3D data reconstruction apparatus according to Embodiment 1 of the present invention.

FIG. 9 is a functional block diagram illustrating internal constitutions of a depth image reconstruction unit and a color image reconstruction unit according to Embodiment 1 of the present invention.

FIG. 10 is a functional block diagram illustrating a constitution of a 3D data generation apparatus according to Embodiment 2 of the present invention.

FIG. 11 is a functional block diagram illustrating an internal constitution of an integrated depth image generation unit according to Embodiment 2 of the present invention.

FIG. 12 is a functional block diagram illustrating a constitution of a 3D data reconstruction apparatus according to Embodiment 2 of the present invention.

FIG. 13 is a functional block diagram illustrating an internal constitution of a depth image reconstruction unit according to Embodiment 2 of the present invention.

FIG. 14 is a functional block diagram illustrating a constitution of a 3D data generation apparatus according to Embodiment 3 of the present invention.

FIG. 15 is a functional block diagram illustrating internal constitutions of an integrated depth image generation unit and an integrated color image generation unit according to Embodiment 3 of the present invention.

FIG. 16 is a diagram illustrating an acquisition example of a depth image and a color image according to Embodiment 3 of the present invention.

FIG. 17 is a diagram illustrating a packing example of the depth images and the color images according to Embodiment 3 of the present invention.

FIG. 18 is a diagram illustrating a packing example of the depth images and the color images according to Embodiment 3 of the present invention.

FIG. 19 is a functional block diagram illustrating a constitution of a 3D data reconstruction apparatus according to Embodiment 3 of the present invention.

### DESCRIPTION OF EMBODIMENTS

Embodiments of the present invention will be described below in detail.

### Embodiment 1

### 3D Data Generation Apparatus

First, a 3D data generation apparatus according to Embodiment 1 of the present invention will be described with reference to the drawings.

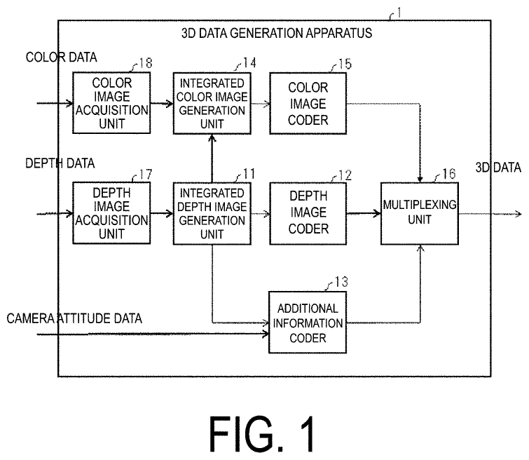

FIG. 1 is a functional block diagram illustrating a constitution of the 3D data generation apparatus according to Embodiment 1 of the present invention. A 3D data generation apparatus 1 includes a depth image acquisition unit 17, an integrated depth image generation unit 11, a depth image coder 12, a color image acquisition unit 18, an integrated color image generation unit 14, a color image coder 15, an additional information coder 13, and a multiplexing unit 16.

The depth image acquisition unit 17 acquires depth data from a plurality of depth cameras, and outputs depth images to the integrated depth image generation unit 11.

The integrated depth image generation unit 11 generates a single integrated depth image by dividing and integrating (packing) the plurality of depth images output from the depth image acquisition unit 17.

The depth image coder 12 performs compression coding on the integrated depth image input from the integrated depth image generation unit 11, and outputs depth coded data. For the compression coding, for example, the High Efficiency Video Coding (HEVC) defined by ISO/IEC 23008-2 can be used.

The color image acquisition unit 18 acquires color data from a plurality of color cameras, and outputs color images to the integrated color image generation unit 14.

The integrated color image generation unit 14 generates a single integrated color image by dividing and integrating (packing) the plurality of color images output from the color image acquisition unit 18.

The color image coder 15 performs compression coding on the integrated color image input from the integrated color image generation unit 14, and outputs color coded data. For the compression coding, for example, the HEVC can be used.

The additional information coder 13 codes additional information necessary to reconstruct the original depth image from the integrated depth image generated by the integrated depth image generation unit 11, and additional information necessary to reconstruct the original color image from the integrated color image generated by the integrated color image generation unit 14, and outputs additional information coded data. Details of the additional information will be described later.

The multiplexing unit 16 multiplexes the respective sets of coded data output from the depth image coder 12, the color image coder 15, and the additional information coder 13, and outputs the resulting data as 3D data. For the multiplexing, for example, the ISO Base Media File Format (ISOBMFF) defined by ISO/IEC 14496-12 can be used. The multiplexed 3D data can be recorded on various recording medium such as a hard disk, an optical disk, a non-volatile memory, and the like, and can be subjected to streaming distribution to the network. For the streaming distribution, for example, the MPEG-Dynamic Adaptive Streaming over HTTP (DASH) defined by ISO/IEC 23009-1 can be used.

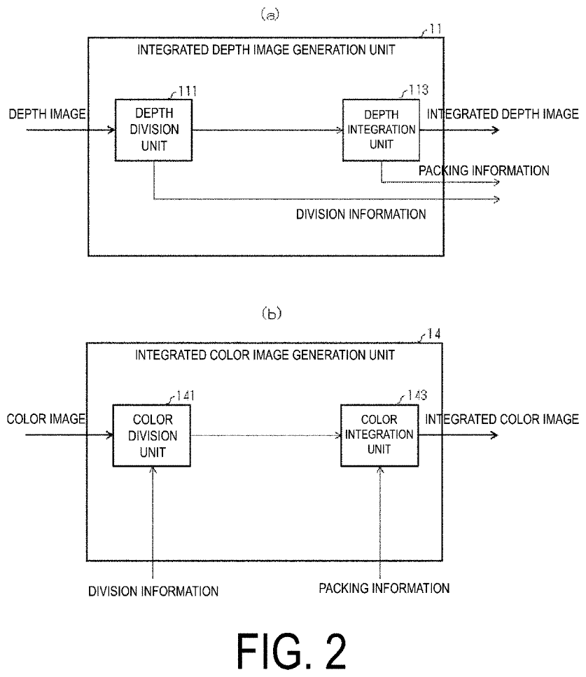

FIG. 2(a) is a functional block diagram illustrating an internal constitution of the integrated depth image generation unit 11 according to Embodiment 1 of the present invention. The integrated depth image generation unit 11 includes a depth division unit 111 and a depth integration unit 113.

The depth division unit 111 divides the depth image output from the depth image acquisition unit 17 into a plurality of partial depth images each of which is formed of a rectangular region. Specifically, a rectangular region is set for each imaging target included in the depth image, a depth image included in the rectangular region is output as the partial depth image, and the following division information is output.

### Example 1 of Division Information

Upper left coordinates of each rectangular region (the upper left of the depth image is taken as the origin)
Lower right coordinates of each rectangular region (the upper left of the depth image is taken as the origin)
An identifier of an imaging target included in each rectangular region

### Example 2 of Division Information

Upper left coordinates of each rectangular region (the upper left of the depth image is taken as the origin)
The width and height of each rectangular region
An identifier of an imaging target included in each rectangular region

The depth integration unit 113 generates an integrated depth image by integrating (packing) the plurality of partial depth images output from the depth division unit 111 into a single image. Specifically, the integrated depth image obtained by integrating all partial depth images is output and the following packing information is output.

### Example 1 of Packing Information

Coordinates on the integrated depth image corresponding to the upper left of each partial depth image (the upper left of the integrated depth image is taken as the origin)
Coordinates on the integrated depth image corresponding to the lower right of each partial depth image (the upper left of the integrated depth image is taken as the origin)
An identifier of an imaging target included in each partial depth image

### Example 2 of Packing Information

Coordinates on the integrated depth image corresponding to the upper left of each partial depth image (the upper left of the integrated depth image is taken as the origin)
The width and height of each partial depth image in the integrated depth image
An identifier of an imaging target included in each partial depth image

The integrated color image generation unit 14 generates a single integrated color image, in accordance with the division information and the packing information output by the integrated depth image generation unit 11, in the same manner as in the integrated depth image generation unit 11, by dividing and integrating (packing) the color images output from the color image acquisition unit 18.

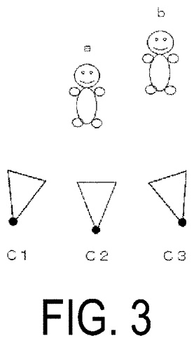

FIG. 3 is a diagram illustrating an acquisition example of the depth image and the color image according to Embodiment 1 of the present invention. A state is illustrated in which, for an imaging target a and an imaging target b, three cameras C1, C2, and C3 are arranged and each camera captures a depth image and a color image.

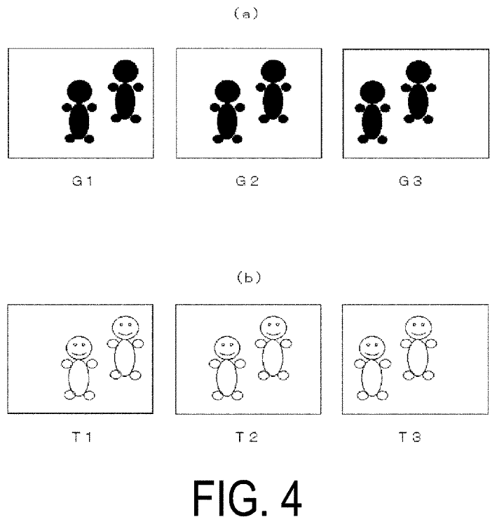

FIG. 4 is a diagram illustrating an example of depth images output by the depth image acquisition unit 17 and color images output by the color image acquisition unit 18 according to Embodiment 1 of the present invention. G1, G2, and G3 in FIG. 4(a) are depth images acquired with the cameras C1, C2, and C3, respectively. T1, T2, and T3 in FIG. 4(b) are color images acquired with the cameras C1, C2, and C3, respectively.

Here, the cameras C1, C2, and C3 can acquire a depth value in a range of 0 mm to 25000 mm, and a value obtained by performing quantization by 16 bits on the acquired depth value is stored in a pixel value of each of the depth images G1, G2, and G3 (e.g., the depth value is stored in a Y component of a YUV 4:2:0 16-bit format). On the other hand, in each of the color images T1, T2, and T3, luminance (Y) and chrominance (U, V) subjected to quantization by 8 bits are stored (e.g., stored in a YUV 4:2:0 8-bit format).

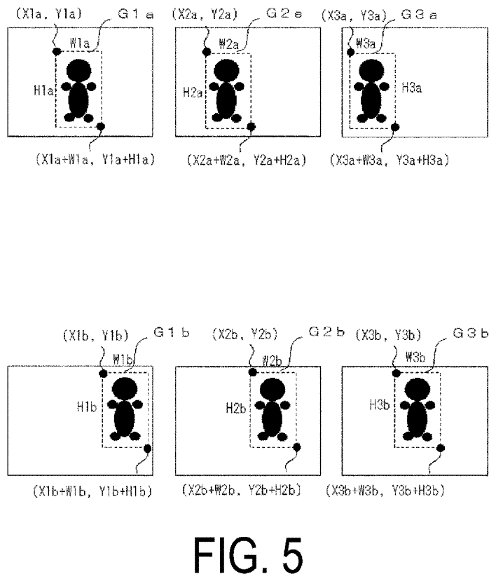

FIG. 5 is a diagram illustrating a division example of the depth images according to Embodiment 1 of the present invention. The depth division unit 111 divides the depth image G1 into a partial depth image G1a of a rectangular region including the imaging target a and a partial depth image G1b of a rectangular region including the imaging target b. In the same manner, the depth image G2 is divided into partial depth images G2a and G2b and the depth image G3 is divided into partial depth images G3a and G3b. The depth division unit 111 outputs the following division information.

### G1a Division Information

Upper left coordinates of the rectangular region: (X1a, Y1a)
Lower right coordinates of the rectangular region: (X1a+W1a, Y1a+H1a)
An identifier of the imaging target included in the rectangular region: a

### G2a Division Information

Upper left coordinates of the rectangular region: (X2a, Y2a)
Lower right coordinates of the rectangular region: (X2a+W2a, Y2a+H2a)
An identifier of the imaging target included in the rectangular region: a

### G3a Division Information

Upper left coordinates of the rectangular region: (X3a, Y3a)
Lower right coordinates of the rectangular region: (X3a+W3a, Y3a+H3a)
An identifier of the imaging target included in the rectangular region: a

### G1b Division Information

Upper left coordinates of the rectangular region: (X1b, Y1b)
Lower right coordinates of the rectangular region: (X1b+W1b, Y1b+H1b)
An identifier of the imaging target included in the rectangular region: b

### G2b Division Information

Upper left coordinates of the rectangular region: (X2b, Y2b)
Lower right coordinates of the rectangular region: (X2b+W2b, Y2b+H2b)
An identifier of the imaging target included in the rectangular region: b

### G3b Division Information

Upper left coordinates of the rectangular region: (X3b, Y3b)
Lower right coordinates of the rectangular region: (X3b+W3b, Y3b+H3b)
An identifier of the imaging target included in the rectangular region: b

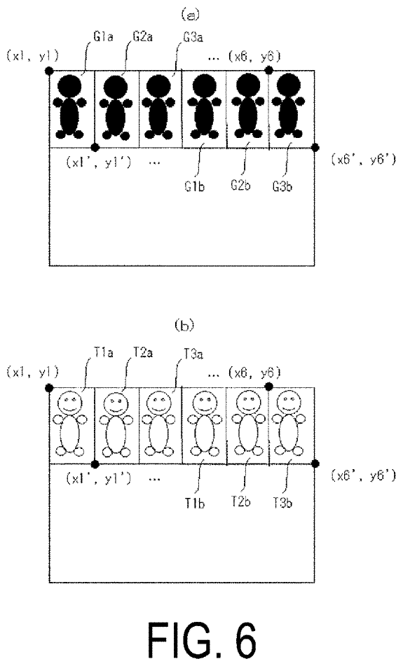

FIG. 6(a) is a diagram illustrating a packing example of the partial depth images according to Embodiment 1 of the present invention. The depth integration unit 113 integrates (packs) the partial depth images G1a, G2a, G3a, G1b, G2b, and G3b into a single image, and generates an integrated depth image. The depth coupling unit 113 outputs the following packing information.

### G1a Packing Information

Coordinates on the integrated depth image corresponding to the upper left of the partial depth image: (x1, y1)
Coordinates on the integrated depth image corresponding to the lower right of the partial depth image: (x1′, y1′)
An identifier of the imaging target included in the partial depth image: a

### G2a Packing Information

Coordinates on the integrated depth image corresponding to the upper left of the partial depth image: (x2, y2)
Coordinates on the integrated depth image corresponding to the lower right of the partial depth image: (x2′, y2′)
An identifier of the imaging target included in the partial depth image: a

### G3a Packing Information

Coordinates on the integrated depth image corresponding to the upper left of the partial depth image: (x3, y3)
Coordinates on the integrated depth image corresponding to the lower right of the partial depth image: (x3′, y3′)
An identifier of the imaging target included in the partial depth image: a

### G1b Packing Information

Coordinates on the integrated depth image corresponding to the upper left of the partial depth image: (x4, y4)
Coordinates on the integrated depth image corresponding to the lower right of the partial depth image: (x4′, y4′)
An identifier of the imaging target included in the partial depth image: b

### G2b Packing Information

Coordinates on the integrated depth image corresponding to the upper left of the partial depth image: (x5, y5)
Coordinates on the integrated depth image corresponding to the lower right of the partial depth image: (x5′, y5′)
An identifier of the imaging target included in the partial depth image: b

### G3b Packing Information

Coordinates on the integrated depth image corresponding to the upper left of the partial depth image: (x6, y6)
Coordinates on the integrated depth image corresponding to the lower right of the partial depth image: (x6′, y6′)
An identifier of the imaging target included in the partial depth image: b

For a background region of each partial depth image in the integrated depth image, coding control is performed based on shape information. The shape information is information indicating whether or not each pixel of the integrated depth image belongs to an object (imaging target), and, for example, “1” in the case of a pixel belonging to the object, or “0” in a case of a pixel not belonging to the object is assigned thereto. In the coding process, for example, in a case that all of the pixels in a coding tree unit (CTU) do not belong to the object, or in a case that some pixels in the CTU do not belong to the object, processing is performed such as padding the region that does not belong to the object in a horizontal direction or a vertical direction with a pixel value of an edge of the object or a prescribed pixel value and then coding, or the like. The depth coupling unit 113 outputs the above-described shape information as the packing information.

FIG. 2(b) is a functional block diagram illustrating an internal constitution of the integrated color image generation unit 14 according to Embodiment 1 of the present invention. The integrated color image generation unit 14 includes a color division unit 141 and a color integration unit 143.

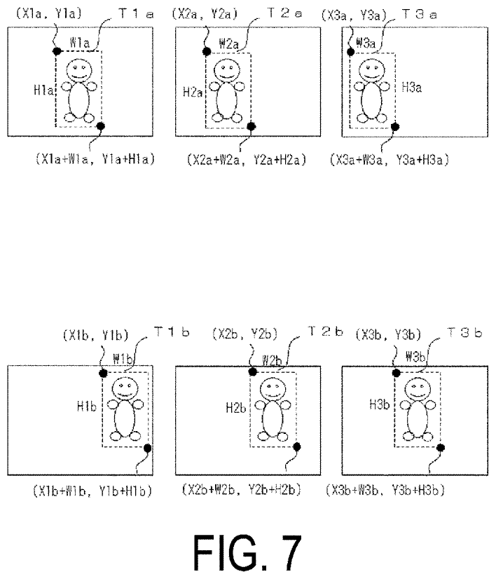

FIG. 7 is a diagram illustrating a division example of the color images according to Embodiment 1 of the present invention. The color division unit 141 divides the color image T1 into a partial color image T1a and T1b in accordance with the division information input from the integrated depth image generation unit 11. In the same manner, the color image T2 is divided into partial color images T2a and T2b, and the color image T3 is divided into partial color images T3a and T3b.

FIG. 6(b) is a diagram illustrating a packing example of the partial color images according to Embodiment 1 of the present invention. The color integration unit 143 integrates (packs) the partial color images T1a, T2a, T3a, T1b, T2b, and T3b into a single image in accordance with the packing information input from the integrated depth image generation unit 11, and generates an integrated color image.

For a background region of each partial color image in the integrated color image, coding control is performed based on the packing information (shape information) input from the integrated depth image generation unit 11. For example, in a case that all of the pixels in a CTU do not belong to the object, or in a case that some pixels in the CTU do not belong to the object, processing is performed such as padding the region that does not belong to the object in a horizontal direction or a vertical direction with a pixel value of an edge of the object or a prescribed pixel value and then coding, or the like.

The depth image coder 12 performs compression coding on the above-described integrated depth image using the HEVC Main12 profile, and outputs depth coded data to the multiplexing unit 16.

The color image coder 15 performs compression coding on the above-described integrated color image using the HEVC Main profile, and outputs color coded data to the multiplexing unit 16.

The additional information coder 13 reversibly codes information related to the division information, the packing information, and each camera pose (position, direction, and the like on the three-dimensional space) output from the integrated depth image generation unit 11, and outputs the result to the multiplexing unit 16.

With the constitution described above, the dynamic range of the depth values in each CTU constituting the partial depth image can be reduced, and resolution at the time of quantization can be improved. As a result, even in a case that the dynamic range of the depth is wide due to the size and movement of the imaging target, insufficient resolution can be solved.

Furthermore, as compared to a case where the depth images (G1, G2, and G3 in FIG. 5(a)) are coupled as they are and coded, a generation code amount can be reduced by reducing the background region and decreasing the image size.

In addition, it is sufficient that, regardless of the number of cameras, three streams of the coded data of the integrated depth image (FIG. 6(a)), the coded data of the integrated color image (FIG. 6(b)), and the coded data of the additional information are transmitted, and therefore an effect that the number of streams to be transmitted can be made not to depend on the number of cameras is achieved.

Furthermore, by determining the size and the number of divisions of the rectangular region by evaluating and optimizing a bit rate of the coded data (depth+color+additional information), coding distortion of the depth image, coding distortion of the color image, and the like, the 3D data of higher quality can be generated.

### 3D Data Reconstruction Apparatus

Next, a 3D data reconstruction apparatus according to Embodiment 1 of the present invention will be described with reference to the drawings.

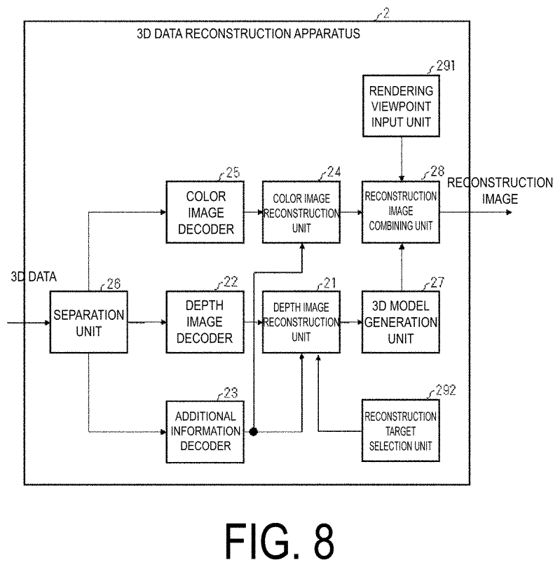

FIG. 8 is a functional block diagram illustrating a constitution of the 3D data reconstruction apparatus according to Embodiment 1 of the present invention. A 3D data reconstruction apparatus 2 includes a separation unit 26, a depth image decoder 22, a depth image reconstruction unit 21, an additional information decoder 23, a color image decoder 25, a color image reconstruction unit 24, a 3D model generation unit 27, a reconstruction image combining unit 28, a rendering viewpoint input unit 291, and a reconstruction target selection unit 292.

The separation unit 26 separates the depth image coded data, the color image coded data, and the additional information coded data included in the input 3D data from one another, and outputs them the depth image decoder 22, the color image decoder 25, and the additional information decoder 23, respectively.

The depth image decoder 22 decodes the depth image coded data input from the separation unit 26 and subjected to HEVC coding. For example, the integrated depth image illustrated in FIG. 6(a) is decoded.

The depth image reconstruction unit 21 reconstructs the depth image, by extracting (depacking) and coupling a desired partial depth image from a plurality of partial depth images included in the integrated depth image decoded by the depth image decoder 22, based on the additional information (division information, packing information) input from the additional information decoder 23.

The color image decoder 25 decodes the color image coded data input from the separation unit 26 and subjected to HEVC coding. For example, the integrated color image illustrated in FIG. 6(b) is decoded.

The color image reconstruction unit 24 reconstructs the color image, by extracting a desired partial color image from a plurality of color images included in the integrated color image decoded by the color image decoder 25, based on the additional information (division information, packing information) input from the additional information decoder 23.

The additional information decoder 23 decodes additional information (division information, packing information) required to reconstruct the depth image and the color image from the additional information coded data input from the separation unit 26.

The 3D model generation unit 27 generates a 3D model based on the plurality of depth images input from the depth image reconstruction unit 21. The 3D model is a model representing the three-dimensional shape of the imaging target, and includes, as one form, a model represented by a mesh.

The reconstruction image combining unit 28 composes a reconstruction image in a rendering viewpoint, based on the 3D model generated by the 3D model generation unit 27, the color image reconstructed by the color image reconstruction unit, and rendering viewpoint information input by a user (position, direction, and the like on the three-dimensional space).

The rendering viewpoint input unit 291 is an input unit to which a rendering viewpoint (position and direction) on the three-dimensional space is input by the user.

The reconstruction target selection unit 292 is a selection unit at which the user selects a desired reconstruction target from a plurality of reconstruction targets.

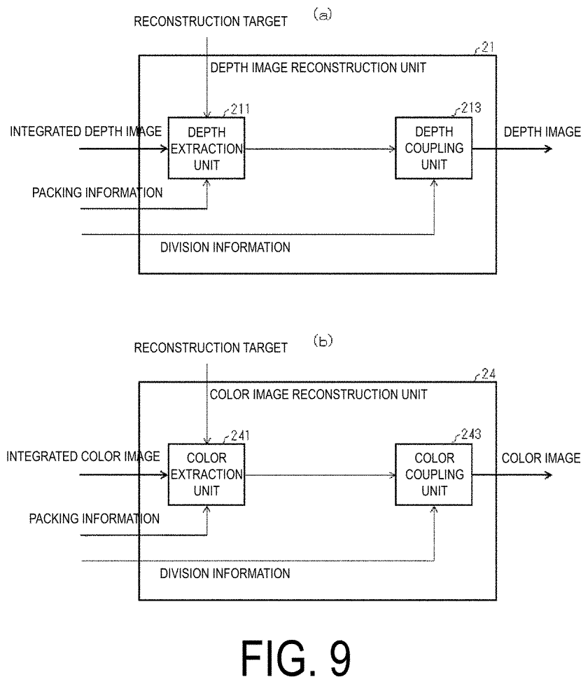

FIG. 9(a) is a functional block diagram illustrating an internal constitution of the depth image reconstruction unit 21 according to Embodiment 1 of the present invention. The depth image reconstruction unit 21 includes a depth extraction unit 211 and a depth coupling unit 213.

The depth extraction unit 211 extracts (depacks) a desired partial depth image from the plurality of partial depth images included in the integrated depth image, based on the packing information input from the additional information decoder 23. For example, in a case that the imaging target a and the imaging target b are selected by the reconstruction target selection unit 292 as reconstruction targets, the partial depth images G1a, G2a, G3a, G1b, G2b, and G3b illustrated in FIG. 5 are extracted and output to the depth coupling unit 213. Alternatively, in a case that only the imaging target b is selected, the partial depth images G1b, G2b, and G3b are extracted and output to the depth coupling unit.

The depth coupling unit 213 reconstructs the depth image, based on the division information input from the additional information decoder 23, by coupling the partial depth images with the same view point from the plurality of partial depth images, and outputs the resulting image to the 3D model generation unit 27. For example, the depth images G1, G2, and G3 illustrated in FIG. 4(a) are output to the 3D model generation unit 27.

FIG. 9(b) is a functional block diagram illustrating an internal constitution of the color image reconstruction unit 24 according to Embodiment 1 of the present invention. The color image reconstruction unit 24 includes a color extraction unit 241 and a color coupling unit 243.

The color extraction unit 241 extracts (depacks) a desired partial color image from the plurality of partial color images included in the integrated color image, based on the packing information input from the additional information decoder 23. For example, in a case that the imaging target a and the imaging target b are selected by the reconstruction target selection unit 292 as reconstruction targets, the partial color images T1a, T2a, T3a, T1b, T2b, and T3b illustrated in FIG. 7 are extracted and output to a color coupling unit 413. Alternatively, in a case that only the imaging target b is selected, the partial color images T1b, T2b, and T3b are extracted and output to the color coupling unit.

The color coupling unit 243 reconstructs the color image, based on the division information input from the additional information decoder 23, by coupling the partial color images with the same view point from the plurality of partial color images, and outputs the resulting image to the reconstruction image combining unit 28. For example, the color images T1, T2, and T3 illustrated in FIG. 4(b) are output to the reconstruction image combining unit 28.

### Embodiment 2

### 3D Data Generation Apparatus

First, a 3D data generation apparatus according to Embodiment 2 of the present invention will be described with reference to the drawings. Note that, for the sake of convenience of description, members having the same functions as the members described in the above embodiment are denoted by the same reference signs, and descriptions thereof will not be repeated.

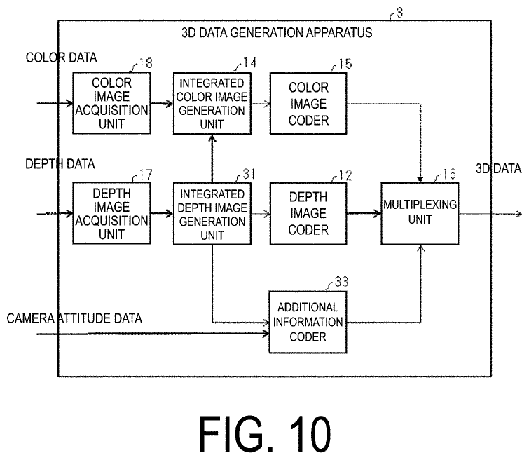

FIG. 10 is a functional block diagram illustrating a constitution of the 3D data generation apparatus according to Embodiment 2 of the present invention. A 3D data generation apparatus 3 includes the depth image acquisition unit 17, an integrated depth image generation unit 31, the depth image coder 12, the color image acquisition unit 18, the integrated color image generation unit 14, an additional information coder 33, and the multiplexing unit 16.

The integrated depth image generation unit 31 generates a single integrated depth image by dividing, quantizing, and integrating (packing) a plurality of depth images output from the depth image acquisition unit 17.

The additional information coder 33 codes additional information necessary to reconstruct the original depth image from the integrated depth image generated by the integrated depth image generation unit 31, and additional information necessary to reconstruct the original color image from the integrated color image generated by the integrated color image generation unit 14, and outputs additional information coded data. Details of the additional information will be described later.

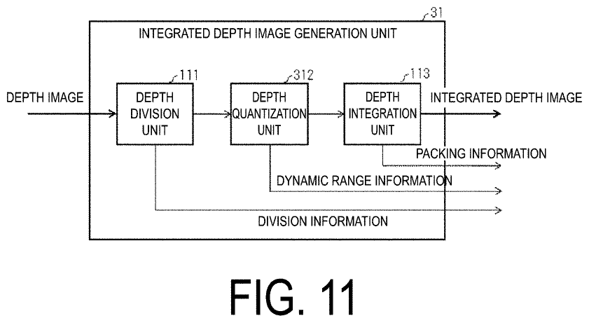

FIG. 11 is a functional block diagram illustrating an internal constitution of the integrated depth image generation unit 31 according to Embodiment 2 of the present invention. The integrated depth image generation unit 31 includes the depth division unit 111, a depth quantization unit 312, and the depth integration unit 113.

In a case that the resolution at the time of quantization is insufficient, such as a case that the dynamic range of the divided partial depth image is greater than a prescribed threshold (e.g. 600 mm), the depth quantization unit 312 quantizes again some partial depth images by a prescribed bit depth (e.g. 12 bits) in accordance with the dynamic range and outputs. The value range of the depth of the partial depth images G1a, G2a, and G3a illustrated in FIG. 5 is 1000 mm to 2000 mm, and the range is subjected to linear quantization by 12 bits again. Furthermore, the value range of the depth of the partial depth images G1b, G2b, and G3b is 2000 mm to 2500 mm, and the input partial depth image is output as it is. The depth quantization unit 312 outputs the minimum value and the maximum value of the value range of the depth of the quantized partial depth image as dynamic range information. For example, as the dynamic range information of the partial depth images G1a, G2a, and G3a, the following information is output.

### G1a Dynamic Range Information

Depth Minimum value: 1000 mm
Depth Maximum value: 2000 mm

### G2a Dynamic Range Information

Depth Minimum value: 1000 mm
Depth Maximum value: 2000 mm

### G3a Dynamic Range Information

Depth Minimum value: 1000 mm
Depth Maximum value: 2000 mm

With the constitution described above, for a partial depth image the resolution of which is insufficient only by the division, resolution at the time of quantization can be improved. As a result, even in a case that the dynamic range of the depth is wide due to the size and movement of the imaging target, insufficient resolution can be solved. For example, in a case that a range of 0 mm to 25000 mm is quantized by 12 bits, the resolution is approximately 6.1 mm (=25000/2\hat{ }12), whereas in a case that a range of 1000 mm to 2000 mm is quantized by 12 bits, the resolution becomes approximately 0.24 mm (=(2000−1000)/2\hat{ }12). As a result, on the reconstruction side, a higher definition 3D model can be generated.

### 3D Data Reconstruction Apparatus

Next, a 3D data reconstruction apparatus according to Embodiment 2 of the present invention will be described with reference to the drawings. Note that, for the sake of convenience of description, members having the same functions as the members described in the above embodiment are denoted by the same reference signs, and descriptions thereof will not be repeated.

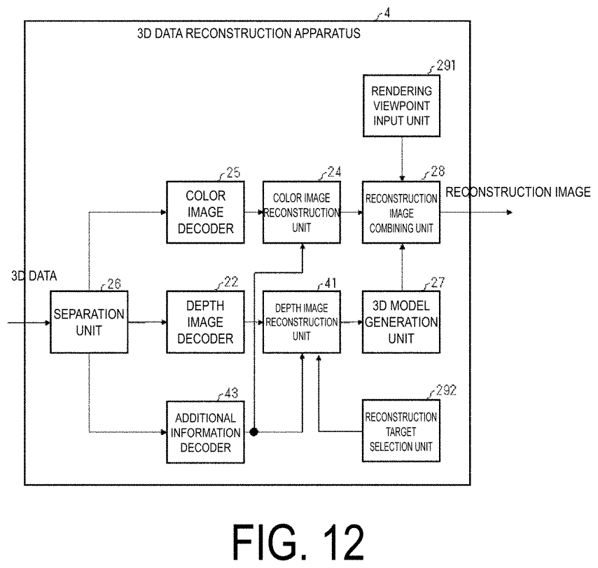

FIG. 12 is a functional block diagram illustrating a constitution of the 3D data reconstruction apparatus according to Embodiment 2 of the present invention. The 3D data reconstruction apparatus 2 includes the separation unit 26, the depth image decoder 22, a depth image reconstruction unit 41, an additional information decoder 43, the color image decoder 25, the color image reconstruction unit 24, the 3D model generation unit 27, the reconstruction image combining unit 28, the rendering viewpoint input unit 291, and the reconstruction target selection unit 292.

The depth image reconstruction unit 41 reconstructs a depth image, by extracting (depacking), inversely quantizing, and coupling a desired partial depth image from a plurality of partial depth images included in the integrated depth image decoded by the depth image decoder 22.

The additional information decoder 43 decodes additional information (division information, packing information, dynamic range information) required to reconstruct the depth image and the color image from the additional information coded data input from the separation unit 26.

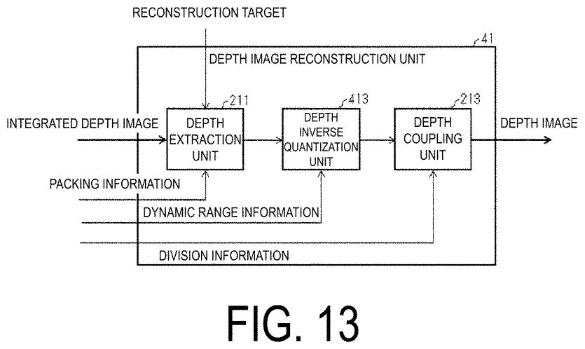

FIG. 13 is a functional block diagram illustrating an internal constitution of the depth image reconstruction unit 41 according to Embodiment 2 of the present invention. The depth image reconstruction unit 41 includes the depth extraction unit 211, a depth inverse quantization unit 412, and the depth coupling unit 213.

The depth inverse quantization unit 412 performs, in a case that dynamic range information corresponding to the extracted partial depth image is present, based on the dynamic range information, inverse quantization on the partial depth image and outputs. Otherwise, the input partial depth image is output as it is.

With the constitution described above, for a partial depth image the resolution of which is insufficient only by the division, resolution at the time of quantization can be improved. As a result, a quantization error in coding of the depth image can be reduced, and a higher definition 3D model can be generated.

### Embodiment 3

### 3D Data Generation Apparatus

First, a 3D data generation apparatus according to Embodiment 3 of the present invention will be described with reference to the drawings. Note that, for the sake of convenience of description, members having the same functions as the members described in the above embodiments are denoted by the same reference signs, and descriptions thereof will not be repeated.

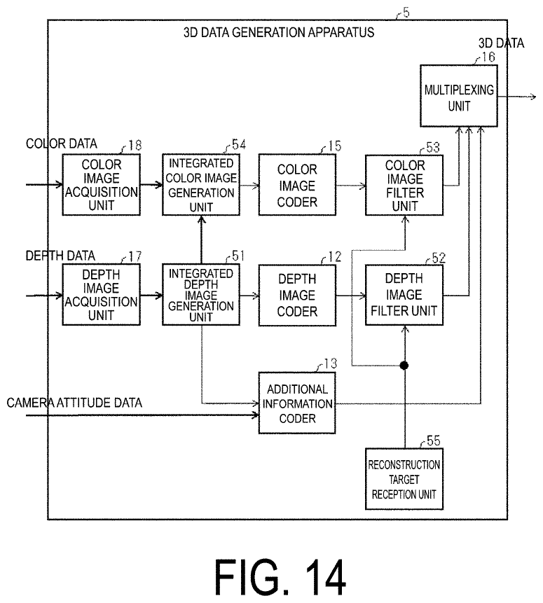

FIG. 14 is a functional block diagram illustrating a constitution of the 3D data generation apparatus according to Embodiment 3 of the present invention. A 3D data generation apparatus 5 includes the depth image acquisition unit 17, an integrated depth image generation unit 51, the depth image coder 12, the color image acquisition unit 18, an integrated color image generation unit 54, the color image coder 15, the additional information coder 13, the multiplexing unit 16, a depth image filter unit 52, a color image filter unit 53, and a reconstruction target reception unit 55.

The integrated depth image generation unit 51 generates a single integrated depth image by dividing a plurality of depth images output from the depth image acquisition unit 17, and integrating (packing) such that a partial depth image of a specific imaging target or a partial depth image in a specific imaging direction is stored in a prescribed coding unit (e.g., HEVC tile).

The integrated color image generation unit 54 generates a single integrated color image, in accordance with the division information and the packing information output by the integrated depth image generation unit 51, in the same manner as in the integrated depth image generation unit 51, by dividing a plurality of color images output from the color image acquisition unit 18, and integrating (packing) such that a partial color image of a specific imaging target or a partial color image in a specific imaging direction is stored in a prescribed coding unit (e.g., HEVC tile).

The depth image filter unit 52 outputs a tile including a reconstruction target (imaging target, imaging direction, and the like) specified by the reconstruction target reception unit 55, among the coded data output from the depth image coder 12. In a case that the reconstruction target is not specified, all tiles are output.

The color image filter unit 53 outputs a tile including a reconstruction target (imaging target, imaging direction, and the like) specified by the reconstruction target reception unit 55, among the coded data output from the color image coder 15. In a case that the reconstruction target is not specified, all tiles are output.

The reconstruction target reception unit 55 receives a request for reconstruction target by the user (e.g., imaging target=a, imaging target=b, imaging direction=front, imaging direction=rear, and the like).

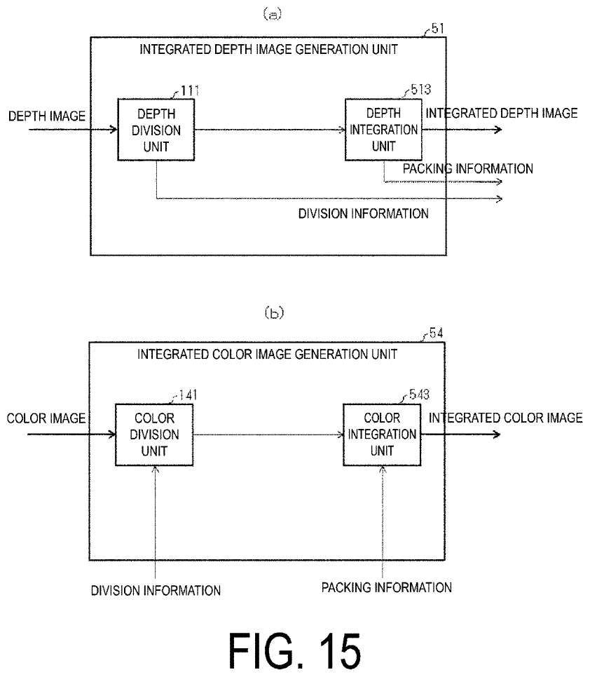

FIG. 15(a) is a functional block diagram illustrating an internal constitution of the integrated depth image generation unit 51 according to Embodiment 3 of the present invention. The integrated depth image generation unit 51 includes the depth division unit 111 and a depth integration unit 513.

The depth integration unit 513 generates a single integrated depth image by integrating (packing) such that a partial depth image of a specific imaging target or a partial depth image in a specific imaging direction is stored in the same tile. Furthermore, the depth integration unit 513 outputs, in addition to the packing information in Embodiment 1, as the packing information, an identifier of an imaging target or an imaging direction of a partial depth image included in each tile.

FIG. 15(b) is a functional block diagram illustrating an internal constitution of the integrated color image generation unit 54 according to Embodiment 3 of the present invention. The integrated color image generation unit 54 includes the color division unit 141 and a color integration unit 543.

The color integration unit 543 generates a single integrated color image, in accordance with the packing information input from the integrated depth image generation unit 51, by integrating (packing) such that a partial color image of a specific imaging target or a partial color image in a specific imaging direction is stored in the same tile.

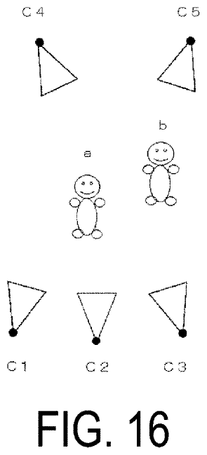

FIG. 16 is a diagram illustrating an acquisition example of a depth image and a color image according to Embodiment 3 of the present invention. A state is illustrated in which, for the imaging target a and the imaging target b, five cameras C1, C2, C3, C4, and C5 are arranged and each camera captures a depth image and a color image.

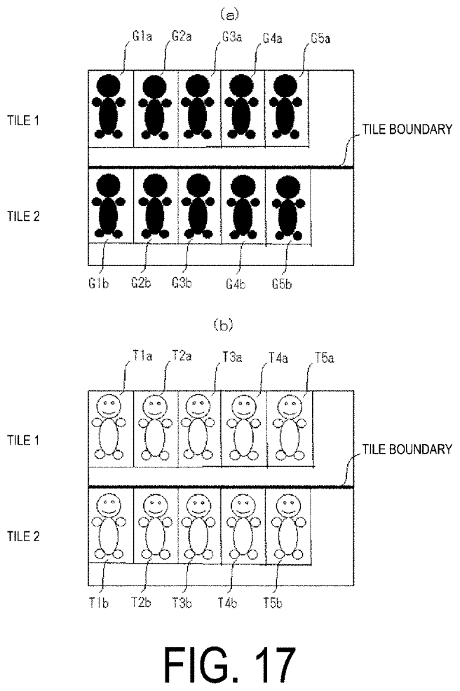

FIG. 17(a) is a diagram illustrating a packing example of the depth images according to Embodiment 3 of the present invention. In this example, the integrated depth image is coded by being divided into two tiles in accordance with the imaging targets. Partial depth images G1a, G2a, G3a, G4a, and G5a of the imaging target a captured by the cameras C1, C2, C3, C4, and C5 are packed to a tile 1, partial depth images G1b, G2b, G3b, G4b, and G5b of the imaging target b captured by the cameras C1, C2, C3, C4, and C5 are packed to a tile 2, and a single integrated depth image is output. Furthermore, the depth integration unit 513 outputs the following packing information.

### Packing Information

The partial depth image included in the tile 1: imaging target=a
The partial depth image included in the tile 2: imaging target=b

For a background region of each partial depth image in the integrated depth image, coding control is performed based on shape information. The shape information is information indicating whether or not each pixel of the integrated depth image belongs to an object (imaging target), and, for example, “1” in the case of a pixel belonging to the object, or “0” in a case of a pixel not belonging to the object is assigned thereto. In the coding process, for example, in a case that all of the pixels in a coding tree unit (CTU) do not belong to the object, or in a case that some pixels in the CTU do not belong to the object, processing is performed such as padding the region that does not belong to the object in a horizontal direction or a vertical direction with a pixel value of an edge of the object or a prescribed pixel value and then coding, or the like. The depth coupling unit 513 outputs the above-described shape information as the packing information.

FIG. 17(b) is a diagram illustrating a packing example of the color images according to Embodiment 3 of the present invention. In the same manner as in the integrated depth image, partial color images T1a, T2a, T3a, T4a, and T5a of the imaging target a are packed to the tile 1, partial color images T1b, T2b, T3b, T4b, and T5b of the imaging target b are packed to the tile 2, and a single integrated color image is output.

For a background region of each partial color image in the integrated color image, coding control is performed based on the packing information (shape information) input from the integrated depth image generation unit 11. For example, in a case that all of the pixels in a CTU do not belong to the object, or in a case that some pixels in the CTU do not belong to the object, processing is performed such as padding the region that does not belong to the object in a horizontal direction or a vertical direction with a pixel value of an edge of the object or a prescribed pixel value and then coding, or the like.

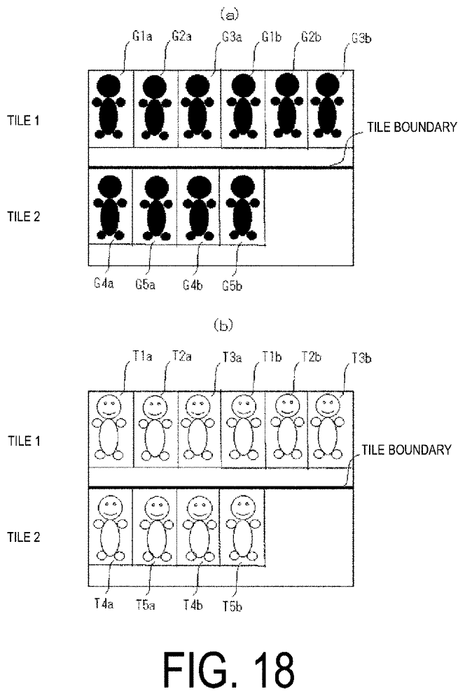

FIG. 18(a) is a diagram illustrating another packing example of the depth images according to Embodiment 3 of the present invention. In this example, the integrated depth image is coded by being divided into two tiles in accordance with the imaging directions. The partial depth images G1a, G2a, G3a, G1b, G2b, and G3b that are captured from the front side by the cameras C1, C2, and C3 are packed to the tile 1, the partial depth images G4a, G5a, G4b, and G5b that are captured from the rear side by the cameras C4, and CS are packed to the tile 2, and a single integrated depth image is output. Furthermore, the depth integration unit 513 outputs the following packing information.

### Packing Information

The partial depth image included in the tile 1: imaging direction=front
The partial depth image included in the tile 2: imaging direction=rear

FIG. 18(b) is a diagram illustrating another packing example of the color images according to Embodiment 3 of the present invention. In the same manner as in the integrated depth image, the partial color images T1a, T2a, T3a, T1b, T2b, and T3b that are captured from the front side are packed to the tile 1, the partial color images T4a, T5a, T4b, and T5b that are captured from the rear side are packed to the tile 2, and a single integrated color image is output.

With the constitution described above, the dynamic range of the depth values in each CTU constituting the partial depth image can be reduced, and resolution at the time of quantization can be improved. As a result, even in a case that the dynamic range of the depth is wide due to the size and movement of the imaging target, insufficient resolution can be solved. Furthermore, in a case that the user desires to reconstruct only a specific imaging target or imaging direction, by transmitting only the tile including the partial depth image of a corresponding imaging target or imaging direction, even in a limited network band such as a mobile environment, 3D data required for reconstruction can be efficiently transmitted. On the reconstruction side, it is sufficient that only some tiles are decoded, and thus the amount of processing required for decoding can be reduced. Furthermore, since the depth image used to generate the 3D model is limited, the amount of processing required to generate the 3D model can be reduced.

Note that in the above description, the HEVC tile has been used as the coding unit, but even other coding units such as the HEVC slice provide the same effect.

### 3D Data Reconstruction Apparatus

Next, a 3D data reconstruction apparatus according to Embodiment 3 of the present invention will be described with reference to the drawings. Note that, for the sake of convenience of description, members having the same functions as the members described in the above embodiments are denoted by the same reference signs, and descriptions thereof will not be repeated.

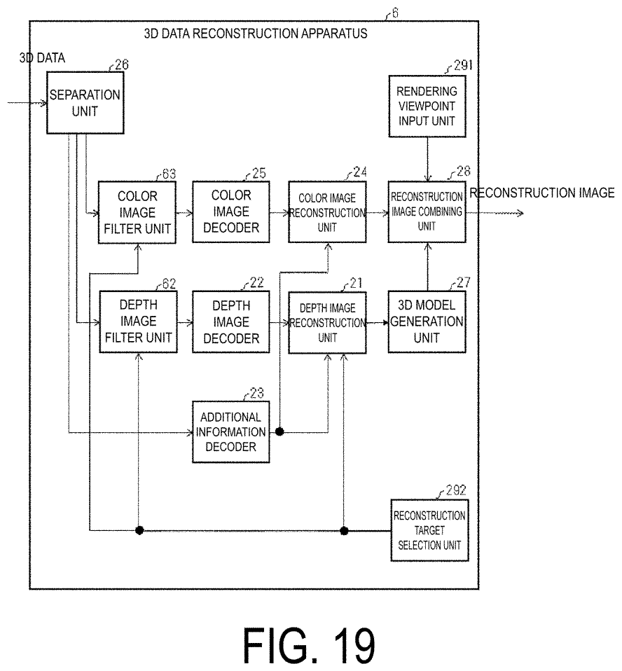

FIG. 19 is a functional block diagram illustrating a constitution of the 3D data reconstruction apparatus according to Embodiment 3 of the present invention. A 3D data reconstruction apparatus 6 includes the separation unit 26, the depth image decoder 22, the depth image reconstruction unit 21, the additional information decoder 23, the color image decoder 25, the color image reconstruction unit 24, the 3D model generation unit 27, the reconstruction image combining unit 28, the rendering viewpoint input unit 291, the reconstruction target selection unit 292, a depth image filter unit 62, and a color image filter unit 63.

The depth image filter unit 62 outputs a tile including a partial depth image corresponding to the reconstruction target (imaging target or imaging direction) specified by the reconstruction target selection unit 292, among the coded data output from the separation unit 26. For example, in a case that “a” is specified as the imaging target, the tile 1 in FIG. 17(a) is output. Alternatively, in a case that the rear is specified as the imaging direction, the tile 2 in FIG. 18(a) is output. In a case that the reconstruction target is not specified, all tiles are output.

Here, a decoding method of some tiles in a case that the tile 1 and the tile 2 in the integrated depth image are stored in the same slice will be described.

Step 1: The reconstruction target selection unit refers to the packing information, and obtains a specified reconstruction target tile number K (K=1 or K=2).

Step 2: The depth image filter unit decodes an entry_point_offset_minus1 syntax element of a slice header, and obtains a byte length N of the coded data of the tile 1.

Step 3: In a case of K=1, the depth image filter unit outputs the slice header and data up to N bytes of slice data. In a case of K=2, the depth image filter unit outputs the slice header and data from N+1 bytes of the slice data.

Step 4: The depth image decoder decodes the slice data of the tile K.

The color image filter unit 63 outputs a tile including a partial color image corresponding to the reconstruction target (imaging target or imaging direction) specified by the reconstruction target selection unit 292, among the coded data output from the separation unit 26. For example, in a case that “a” is specified as the imaging target, the tile 1 in FIG. 17(b) is output. Alternatively, in a case that the rear is specified as the imaging direction, the tile 2 in FIG. 18(b) is output. In a case that the reconstruction target is not specified, all tiles are output.

In the same manner, a decoding method of some tiles in a case that the tile 1 and the tile 2 in the integrated color image are stored in the same slice will be described.

Step 1: The reconstruction target selection unit refers to the packing information, and obtains a specified reconstruction target tile number K (K=1 or K=2).

Step 2: The color image filter unit decodes an entry_point_offset_minus1 syntax element of a slice header, and obtains a byte length N of the coded data of the tile 1.

Step 3: In a case of K=1, the color image filter unit outputs the slice header and data up to N bytes of slice data. In a case of K=2, the color image filter unit outputs the slice header and data from N+1 bytes of the slice data.

Step 4: The color image decoder decodes the slice data of the tile K.

The above described constitution makes it possible to easily perform control of the reconstruction target in accordance with processing capability of the terminal in such a manner that, in a reconstruction terminal with high processing capability, by decoding all of the tiles and generating the 3D model as a whole, all of the imaging targets or the imaging directions can be reconstructed, and in a reconstruction terminal with low processing capability, by decoding only some tiles and partially generating the 3D model, only a specific imaging target or imaging direction can be reconstructed, and the like.

### Implementation Examples by Software

The control blocks (e.g., integrated depth image generation unit 11, integrated color image generation unit 14) of the 3D data generation apparatus 1 and the control blocks (e.g., depth image reconstruction unit 21, color image reconstruction unit 24) of the 3D data reconstruction apparatus 2 may be achieved with a logic circuit (hardware) formed as an integrated circuit (IC chip) or the like, or may be achieved with software.

In the latter case, each of the 3D data generation apparatus 1 and the 3D data reconstruction apparatus 2 includes a computer that performs instructions of a program that is software for achieving each function. The computer includes at least one processor (control device), for example, and includes at least one computer-readable recording medium having the program stored thereon. On the computer, the processor reads from the recording medium and performs the program to achieve the object of the present invention. A Central Processing Unit (CPU) can be used as the processor, for example. As the above-described recording medium, a “non-transitory tangible medium” such as a tape, a disk, a card, a semiconductor memory, and a programmable logic circuit, for example, in addition to a Read Only Memory (ROM) and the like, can be used. Furthermore, a Random Access Memory (RAM) or the like for deploying the above-described program may be further provided. The above-described program may be supplied to the above-described computer via an arbitrary transmission medium (such as a communication network and a broadcast wave) capable of transmitting the program. Note that one aspect of the present invention may also be implemented in a form of a data signal embedded in a carrier wave in which the program is embodied by electronic transmission.

### Supplement

A 3D data generation apparatus according to Aspect 1 of the present invention is a 3D data generation apparatus to which a depth image representing a three-dimensional shape of one or a plurality of imaging targets is input and which generates 3D data, the 3D data generation apparatus including: a depth division unit configured to divide the depth image into a plurality of partial depth images including a rectangular region; a depth integration unit configured to perform packing of the plurality of partial depth images and to generate an integrated depth image; a depth image coder configured to code the integrated depth image; and an additional information coder configured to code additional information including division information for specifying the rectangular region and information for indicating the packing.

In the 3D data generation apparatus according to Aspect 2 of the present invention, the additional information may further include information for indicating a dynamic range of a depth value in a partial depth image of the plurality of partial depth images, and the 3D data generation apparatus further includes a depth quantization unit configured to quantize the plurality of partial depth images based on the dynamic range.

In the 3D data generation apparatus according to Aspect 3 of the present invention, the depth integration unit may pack a partial depth image having an identical imaging target into an identical coding unit.

In the 3D data generation apparatus according to Aspect 4 of the present invention, the depth integration unit may pack a partial depth image having an identical imaging direction into an identical coding unit.

A 3D data reconstruction apparatus according to Aspect 5 of the present invention is a 3D data reconstruction apparatus to which 3D data are input and which reconstructs a three-dimensional shape of one or a plurality of imaging targets, the 3D data reconstruction apparatus including: a depth image decoder configured to decode an integrated depth image included in the 3D data; an additional information decoder configured to decode additional information including information for indicating packing of a plurality of partial depth images each including a rectangular region included in the integrated depth image and division information for specifying the rectangular region; a depth extraction unit configured to extract, from the integrated depth image which is decoded, a partial depth image of the plurality of partial depth images based on the information for indicating the packing; and a depth coupling unit configured to couple the plurality of partial depth images based on the division information and reconstruct a depth image.

In the 3D data reconstruction apparatus according to Aspect 6 of the present invention, the additional information may further include information for indicating a dynamic range of a depth value in a partial image of the plurality of partial depth images, and the 3D data reconstruction apparatus further includes a depth inverse quantization unit configured to inversely quantize the plurality of partial depth images based on the dynamic range.

In the 3D data reconstruction apparatus according to Aspect 7 of the present invention, a partial depth image of the plurality of partial depth images having an identical imaging target is coded to an identical coding unit in the 3D data.

In the 3D data reconstruction apparatus according to Aspect 8 of the present invention, a partial depth image of the plurality of partial depth images having an identical imaging direction is coded to an identical coding unit in the 3D data.

The 3D data generation apparatus according to each aspect of the present invention may be implemented by a computer. In this case, a control program of the 3D data generation apparatus configured to cause a computer to operate as each unit (software component) included in the 3D data generation apparatus to implement the 3D data generation apparatus by the computer and a computer-readable recording medium configured to record the control program are also included in the scope of the present invention.

The present invention is not limited to each of the above-described embodiments. It is possible to make various modifications within the scope of the claims. An embodiment obtained by appropriately combining technical elements each disclosed in different embodiments falls also within the technical scope of the present invention. Further, in a case that technical elements disclosed in the respective embodiments are combined, it is possible to form a new technical feature.

### CROSS-REFERENCE OF RELATED APPLICATION

This application claims the benefit of priority to JP 2018-183903 filed on Sep. 28, 2018, which is incorporated herein by reference in its entirety.

### REFERENCE SIGNS LIST

1 3D data generation apparatus
11 Integrated depth image generation unit
111 Depth division unit
113 Depth integration unit
12 Depth image coder
13 Additional information coder
14 Integrated color image generation unit
15 Color image coder
16 Multiplexing unit
17 Depth image acquisition unit
18 Color image acquisition unit
2 3D data reconstruction apparatus
21 Depth image reconstruction unit
211 Depth extraction unit
213 Depth coupling unit
22 Depth image decoder
23 Additional information decoder
24 Color image reconstruction unit
25 Color image decoder
26 Separation unit
27 3D model generation unit
28 Reconstruction image combining unit
291 Rendering viewpoint input unit
292 Reconstruction target selection unit
3 3D data generation apparatus
31 Integrated depth image generation unit
33 Additional information coder
312 Depth quantization unit
4 3D data reconstruction apparatus
41 Depth image reconstruction unit
43 Additional information decoder
413 Depth inverse quantization unit
5 3D data generation apparatus
51 Integrated depth image generation unit
513 Depth integration unit
54 Integrated color image generation unit
543 Color integration unit
52 Depth image filter unit
53 Color image filter unit
6 3D data reconstruction apparatus
62 Depth image filter unit
63 Color image filter unit

1-8. (canceled)

9. A 3D data generation apparatus for generating 3D data by using a depth image representing a three-dimensional shape of an imaging target, the 3D data generation apparatus comprising:
a depth integration circuitry that generates an integrated depth image by packing at least two partial depth images, wherein each of the partial depth images is a rectangular region represented in the depth image;
a depth image coder that codes the integrated depth image; and
an additional information coder that codes (i) divisional information specifying positions of a top left sample of a partial depth image in the depth image and (ii) packing information specifying positions of a top left sample of a partial depth image for the integrated depth image,
wherein
the additional information coder codes dynamic range information specifying a minimum value and a maximum value for deriving a depth value.

10. The 3D data generation apparatus of claim 9, wherein
the depth integration circuitry derives shape information indicating whether the integrated depth image is included in an imaging target.

11. A 3D data generation method for generating 3D data by using a depth image representing a three-dimensional shape of an imaging target, the 3D data generation method including:
generating an integrated depth image by packing at least two partial depth images, wherein each of the partial depth images is a rectangular region represented in the depth image;
coding the integrated depth image;
coding divisional information specifying positions of a top left sample of a partial depth image in the depth image;
coding packing information specifying positions of a top left sample of a partial depth image for the integrated depth image; and
coding dynamic range information specifying a minimum value and a maximum value for deriving a depth value.

12. A 3D data reconstruction apparatus for reconstructing a three-dimensional shape of an imaging target, the 3D data reconstruction apparatus comprising:
a depth integration circuitry that reconstructs an integrated depth image by packing at least two partial depth images, wherein each of the partial depth images is a rectangular region represented in the depth image;
a depth image decoder that decodes the integrated depth image; and
an additional information decoder that decodes (i) divisional information specifying positions of a top left sample of a partial depth image in the depth image and (ii) packing information specifying positions of a top left sample of a partial depth image for the integrated depth image,
wherein
the additional information decoder decodes dynamic range information specifying a minimum value and a maximum value for deriving a depth value.
